(19) United States
(12) Patent Application Publication
(10) Pub. No.: US 2007/0289495 A1
(43) Pub. Date: Dec. 20, 2007

(54) Silicone Release Coating Compositions

(75) Inventors: Stephen Edward Cray, Sully (GB); David Rich, Barry (GB); Marc Thibaut, Godarville (BE)

Correspondence Address: DOW CORNING CORPORATION CO1232, 2200 W. SALZBURG ROAD, P.O. BOX 994, MIDLAND, MI, 48686-0994, US

(73) Assignee: Dow Corning Corporation

(21) Appl. No.: 11/665,432

(22) PCT Filed: Oct. 31, 2005
(86) PCT No.: PCT/US05/39380

§ 371 Date: Apr. 13, 2007

Related U.S. Application Data
(60) Provisional application No. 60/629,257, filed on Nov. 18, 2004.

(51) Int. Cl. C07F 7/08; C08G 77/20; C09D 183/04; C09J 7/02

(52) U.S. Cl. 106/287.14; 556/462

(57) ABSTRACT

Novel branched siloxanes, silicone release coating compositions containing the branched siloxanes, and silicone release modifier compositions containing the branched siloxanes comprise compositions having the formula: wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups.

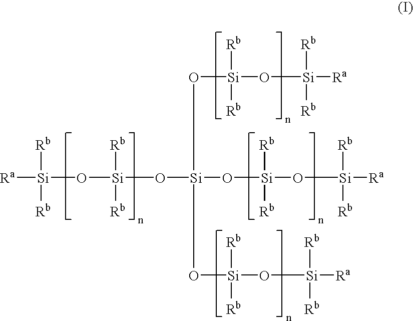

This invention is related to novel branched siloxanes, silicone release coating compositions, and silicone release modifier compositions, containing the novel branched siloxane.

Silicone release coatings are useful in applications where relatively non-adhesive surfaces are required. Single sided liners, such as backing papers for pressure sensitive adhesive labels, are usually adapted to temporarily retain the labels without affecting the adhesive properties of the labels. Double sided liners, such as interleaving papers for double sided and transfer tapes, are utilized to ensure the protection and desired unwind characteristics of a double sided self-adhesive tape or adhesive film.

Substrates such as single sided liners are coated by applying silicone release coating compositions onto the substrate, and subsequently curing the composition by thermally initiated hydrosilylation.

The basic constituents of silicone release coating compositions which are cured by hydrosilylation are:

(i) an alkenylated polydiorganosiloxane which can be a linear polymer or a branched polymer containing terminal and/or pendant alkenyl groups, most typically a linear polymer containing terminal alkenyl groups,

(ii) a polyorganohydrogensiloxane cross-linking agent designed to cross-link the alkenylated polydiorganosiloxane, and

(iii) a catalyst to catalyze the cross-linking reaction.

Often a fourth constituent comprising an inhibitor (iv) is also included in the composition which is designed to prevent the commencement of curing below a prerequisite cure temperature. Silicone release coating compositions consisting of the three essential constituents (i)-(iii) and optionally the inhibitor (iv), are generally referred to as premium silicone release coating compositions. In order to control the level of release force from such silicone release coatings, it has become common practice in the art for silicone release coating compositions to contain another additive known as a release modifier. The release modifier typically replaces a proportion of the alkenylated polydiorganosiloxane (i) in premium silicone release coating compositions.

Improvements in the performance of silicone release coatings are continuously being sought with respect to properties such as ease of cure, i.e. the decrease in cure times at relatively low temperatures, anchorage of coatings to substrates, and release performance. One factor which particularly necessitates continued development of such silicone release coatings is the use of an ever increasing number of substrates such as polypropylene, polyethylene, and polyester, onto which such silicone release coating compositions are applied and cured.

As is known in the silicone art, the structure of siloxanes can be identified with reference to certain units contained in a siloxane structure. These units have been designated as M, D, T and Q units, which represent, respectively, units with the empirical formulae R₃SiO_{1/2}, R₂SiO_{2/2}, RSiO_{3/2} and SiO_{4/2}, wherein each R group represents a monovalent substituent. The letter designations M, D, T, and Q, refer respectively, to the fact that the unit is monofunctional, difunctional, trifunctional, or tetrafunctional. These M, D, T, and Q structural units are depicted below for the sake of clarity.

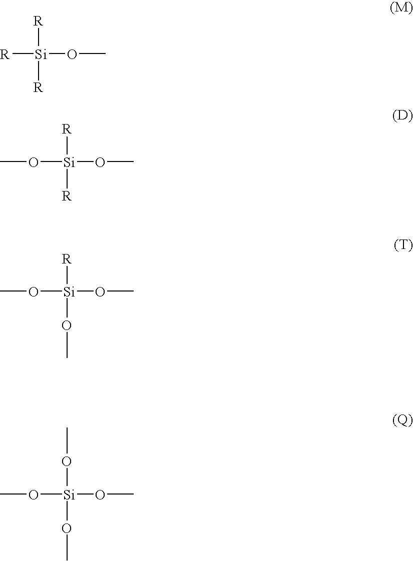

Siloxanes of the general structure MD₄Q are generally known in the art. Reference may be had to U.S. Pat. No. 4,386,135 (May 31, 1983), which discloses MD₄Q siloxanes of the formula: 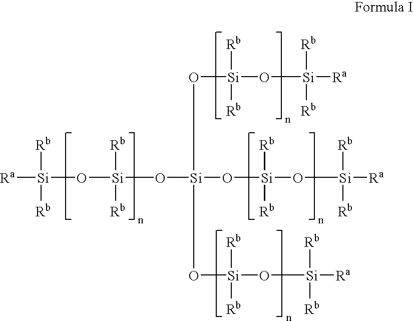
wherein each R^{a} substituent is an alkenyl group having 2-6 carbon atoms such as vinyl, and the R^{b} substituent generally comprises an alkyl group such as methyl. The '135 patent discloses only siloxane structures of the type M₄^{Vi}D₄Q, wherein the M group in that structure is —Si(CH₃)₂CH═CH₂. Thus, all four of the M units in the '135 patent contain vinyl, i.e., fully vinylated.

U.S. Pat. No. 5,077,369 (Dec. 31, 1991) is another example disclosing siloxanes of the structure MD₄Q having Formula I, but wherein only 2 or 3 of the R^{a} substituents are alkenyl groups having 2-6 carbon atoms such as vinyl, and the R^{b} substituent generally comprises an alkyl group such as methyl. The '369 patent discloses only M₂^{Vi}D₄Q type siloxanes and M₃^{Vi}D₄Q type siloxanes, wherein the M group in those two structures is —Si(CH₃)₂CH═CH₂. Thus, only 2 or 3 of the M units in the '369 patent contain vinyl. The remaining M units in the '369 patent have the structure —Si(CH₃)₃, i.e., partially trimethylated in contrast to fully vinylated.

A third example is U.S. Pat. No. 6,528,608 (Mar. 4, 2003) which discloses siloxanes of the structure MD₄Q having Formula I, wherein at least 3 of the R^{a} substituents are alkenyl groups having 2-6 carbon atoms such as vinyl, and the R^{b} substituent generally comprises an alkyl group such as methyl. The '608 patent discloses only M₃^{Vi}D₄Q type siloxanes and M₄^{Vi}D₄Q type siloxanes, wherein the M group in those two structures is —Si(CH₃)₂CH═CH₂. Thus, only 3 or 4 of the M units in the '608 patent contain vinyl. The remaining M units in the '608 patent have the structure —Si(CH₃)₃, i.e., partially trimethylated in contrast to fully vinylated

Applicants are not aware of anything in the public domain for M^{Vi}D₄Q type siloxanes which are limited to M_{3.2-3.9}^{Vi}D₄Q. These type siloxanes comprise the branched siloxanes according to the present invention, and have the structure corresponding to the formula set forth below in the Detailed Description of The Invention. These branched siloxanes can contain combinations of trimethylsilyl end groups and vinyl end groups, and have been found to display improved properties such as better (i) anchorage as measured by delayed rub-off resistance, better (ii) cure characteristics to filmic surfaces such as polyester, and (iii) a reduced tendency to show zippiness behavior, which are superior to siloxanes of the type noted above.

For example, one of the requirements in silicone release coatings is the ability to be able to control the release forces at a range of peel speeds on a wide range of substrates including paper and filmic substrates. More recently, requirements have aimed at achieving lower release forces at higher peel speeds greater than 10 meter per minute. It has been found unexpectedly that the trimethylsilyl, vinyldimethylsilyl terminated poly(dimethylsiloxane-silicate) copolymers according to the present invention, show low release forces at high speed, when combined with an organohydrogen polysiloxane cross-linking agent, a hydrosilylation catalyst, and optionally a silicone release modifier.

Another requirement for silicone release coating compositions is that they obtain smooth release profiles, i.e., a constant release force during the whole step of a delaminating process of removing a silicone release liner from the label feedstock. Some adhesives, especially hot melt adhesives, tend to render release profiles which provide a regular and high variation in release forces values. This phenomena called zippiness is especially apparent at low delamination speeds. Zippiness, often referred to in the art as chatter, is a complex energy dissipating process that leads to so-called initiation spikes at higher delamination speeds that are manifest as a peak of release force at the initiation point in time of delamination. The presence of and intensity of the initiation spikes leads to practical problems such as web breakage or labels that cannot be delaminated from the liner, but can be eliminated or ameliorated by the silicone release coating compositions according to the invention. Thus, it's been discovered that the trimethylsilyl, vinyldimethylsilyl terminated poly(dimethylsiloxane-silicate) copolymers according to the present invention are capable of significantly reducing the level of initiation spike or initiation force and therefore subsequently zippiness phenoma.

This invention is directed to a branched siloxane having Formula I as above, wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups.

The invention is also directed to a method of preparing branched siloxanes by:

(A) mixing:

(i) a compound of the formula (SiO_{4/2})(R^{a}R^{b}₂SiO_{1/2})₄;

(ii) a cyclic polydiorganosiloxane; and

(iii) a substantially linear trimethylsiloxy terminated polydiorganosiloxane; or

(iv) a compound having the general formula (SiO_{4/2})(R^{c}R^{d}₂SiO_{1/2})₄;

wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; R^{c} is an hydroxy group, an alkoxy group, or an alkyl group; and R^{d} is the same as R^{b}.

(B) causing the mixture in (A) to react in the presence of an acid catalyst or a phosphazene base catalyst at a temperature less than about 180° C.; and

(C) neutralizing the reaction mixture of (B).

The invention is further directed to a silicone release coating composition containing:

(i) the branched siloxane as shown above;

(ii) an organohydrogenpolysiloxane cross-linking agent, in an amount such that the ratio of total number of Si—H groups in the silicone release coating composition to aliphatically unsaturated hydrocarbon groups in the silicone release coating composition is 1:1 to 5:1;

(iii) a sufficient amount of a hydrosilylation catalyst effective to catalyze the reaction between branched siloxane (i) and cross-linking agent (ii); and

(iv) at least one of a hydrosilylation inhibitor, a linear alkenyl terminated polydiorganosiloxane, a bath life extender, a silicone release modifier, an adhesion promoter, a filler, a reactive diluent, or an anchorage improving additive.

Additionally, the invention is directed to a multi-pack silicone release coating composition, which in a first embodiment is in the form of a kit that includes a first pack containing the branched siloxane (i) and the hydrosilylation inhibitor, a second pack containing the silicone release modifier and the hydrosilylation inhibitor, a third pack containing the (iii) hydrosilylation catalyst, and a fourth pack containing the organohydrogenpolysiloxane cross-linking agent (ii).

In a second embodiment, the multi-pack silicone release coating composition is in the form of a kit that includes a first pack containing the branched siloxane (i) and the hydrosilylation catalyst (iii), a second pack containing the silicone release modifier and the hydrosilylation catalyst (iii), and a third pack containing the organohydrogenpolysiloxane cross-linking agent (ii) and the hydrosilylation inhibitor.

In a third embodiment, the multi-pack silicone release coating composition is in the form of a kit that includes a first pack containing the branched siloxane (i), the organohydrogenpolysiloxane cross-linking agent (ii), optionally a release modifier and the hydrosilylation inhibitor, and a second pack containing the branched siloxane (i) and the hydrosilylation catalyst (iii).

Furthermore, the invention is directed to a silicone release modifier composition containing the branched siloxane as shown above, and (B) at least one of (i) an alkenylated silicone resin, (ii) an alkenylated polydiorganosiloxane, (iii) a primary alkene containing 14-30 carbon atoms, or (iv) a branched alkene containing at least 14 carbon atoms. These and other features of the invention will become apparent from a consideration of the detailed description.

The branched siloxanes according to the present invention have a structure generally corresponding to Formula I as above: 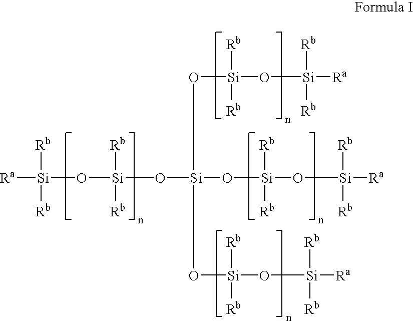
wherein each R^{a} substituent is an alkyl group having 1-6 carbon atoms, an alkenyl group having 2-6 carbon atoms, or an alkynyl group having 2-6 carbon atoms; each R^{b} substituent is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} substituents in the branched siloxane are alkenyl or alkynyl groups.

Each R^{a} substituent and R^{b} substituent may contain alkyl groups such as methyl, ethyl, propyl, isopropyl, butyl, pentyl or hexyl, preferably methyl and ethyl, most preferably methyl. Each R^{a} substituent and R^{b} substituent may also contain alkenyl groups such as vinyl, allyl, butenyl, pentenyl, or hexenyl, preferably a vinyl or hexenyl group. Some examples of suitable alkynyl groups for the R^{a} substituent are acetylenyl, propynyl, 1-butynyl, 1-pentynyl, and 1-hexynyl. An example of a suitable aryl group for the R^{b} substituent is phenyl. The R^{b} substituent may also contain alkoxy groups such as methoxy, ethoxy, propoxy, or butoxy; acrylate groups such as acryloxypropyl; or methacrylate groups such as methacryloxypropyl.

Branched siloxanes according to the invention have a viscosity of about 50 mm²/s (centistoke) to about 10,000 mm²/s (centistoke) at 25° C., preferably a viscosity of 50-1,000 mm²/s (centistoke). The number of siloxane units in the branched siloxane, i.e., the degree of polymerization (DP), should be from 20 to 1,000, preferably 50-800, and most preferably 80-300.

The method for the preparation of the branched siloxane involves mixing (i) a compound having the general formula (SiO_{4/2})(R^{a}R^{b}₂SiO_{1/2})₄ with (ii) a cyclic polydiorganosiloxane; and/or (iii) a substantially linear trimethylsiloxy terminated polydiorganosiloxane, or (iv) a compound having the general formula (SiO_{4/2})(R^{c}R^{d}₂SiO_{1/2})₄. Each R^{a} substituent and R^{b} substituent have the same meaning as noted above. The R^{d} substituent is the same as the R^{b} substituent. The R^{c} substituent comprises an hydroxy group, an alkoxy group such as ethoxy, or an alkyl group such as methyl.

A mixture containing compounds (i) and (ii), and optionally compounds (iii) and (iv), is caused to react in the presence of an acid or phosphazene base catalyst, at a temperature of less than about 180° C., and then the reaction mixture is neutralized.

Each cyclic polydiorganosiloxane should contain 3-10 of the R^{b}₂SiO_{2/2} units, although it is preferred that the cyclic polydiorganosiloxane comprise polydialkylsiloxane rings consisting of 3-6 repeating R^{b}₂SiO_{2/2} units in which each R^{b} substituent is the methyl group.

The reaction which takes place is either an acid or a base catalyzed equilibration reaction, dependent on the chosen catalyst. For acid catalyzed equilibration reactions, the acid catalyst may be any catalyst suitable for catalysis of acid based equilibration reactions, including compositions such as trifluoromethyl sulphonic acid; and acid clays including Amberlyst and phosphonitrile chloride. The preferred catalyst is trifluoromethane sulphonic acid.

For basic catalyzed equilibration preparations, the catalyst may be any suitable strong base catalyst including phosphazene base catalysts such as phosphazene bases having any of the following formulae:
((R¹₂N)₃P═N—)ₖ(R¹₂N)₃₋ₖP═NR²
[((R¹₂N)₃P═N—)ₖ(R¹₂N)₃₋ₖP—N(H)R²]⁺[A⁻] or
[((R¹₂N)₃P═N—)₁(R¹₂N)₄₋₁P]⁺[A]⁻

In the above formulas, R¹ may be the same or different in each position, and R¹ can be hydrogen or an optionally substituted hydrocarbon group, preferably a C₁-C₄ alkyl group. There may also be two R¹ groups bonded to the same N atom and linked to complete a heterocyclic ring, preferably a 5- or 6-membered ring.

R² can be hydrogen or an optionally substituted hydrocarbon group, preferably a C₁-C₂₀ alkyl group, more preferably a C₁-C₁₀ alkyl group. In the formulas, k is 1, 2 or 3, preferably 2 or 3; l is 1, 2, 3 or 4, preferably 2, 3 or 4; and A is an anion such as fluoride, hydroxide, silanolate, alkoxide, carbonate, or bicarbonate. Particularly preferred compositions are aminophosphazenium hydroxides.

For acid catalyzed equilibration reactions, the reaction mixture is preferably maintained at a temperature of 75-120° C., most preferably 80-90° C., and can be carried out in the presence of water as a co-catalyst. For base catalyzed equilibration reactions, the reaction mixture is preferably maintained at a temperature of 120-160° C., most preferably 130-150° C. Any appropriate neutralizing agent may be used, dependent upon whether the catalyst is acidic or basic in nature. Neutralizing agents which may be used include compositions such as bis-trimethylsilylhydrogenphosphate for base catalyzed equilibrium reactions, and calcium carbonate for acid catalyzed equilibration reactions.

The amount of each constituent used in the method is dependent on two factors, one factor being the required degree of polymerization of the branched siloxane, and the other factor being the number of alkenyl groups required in the branched siloxane. Preferably, there will be 1-25 percent by weight of the compound (SiO_{4/2})(R^{a}R^{b}₂SiO_{1/2})₄ in the initial mixture, more preferably 1-11 percent by weight, most preferably 2-7 percent by weight. The remainder of the initial mixture up to 100 percent by weight comprises (ii) the cyclic polydiorganosiloxane, and/or the compounds (iii) and (iv).

Silicone release coating composition according to the present invention typically contain the following ingredients:

(i) a branched siloxane as described above;

(ii) an organohydrogenpolysiloxane cross-linking agent in an amount such that the ratio of the total number of Si—H groups in the silicone release coating composition to aliphatically unsaturated hydrocarbon groups in the silicone release coating composition is from 1:1 to 5:1; and

(iii) a sufficient amount of a hydrosilylation catalyst effective to catalyze the reaction between the branched siloxane and the cross-linking agent.

The organohydrogenpolysiloxane cross linking agent should contain at least three Si—H groups, and has a structure corresponding to the formula:
R^{t}₃SiO_{1/2}((CH₃)₂SiO_{2/2})_{d}(R^{t}₂SiO_{2/2})ₑ)SiO_{1/2}R^{t}₃
wherein each R^{t} is an alkyl group having 1-4 carbon atoms, an epoxy group such as allylglycidoxy and ethylcyclohexylepoxy, or hydrogen; d is 0 or a positive number; e is an integer such that d+e is from 8-100. Alternatively, the cross-linking agent may comprise an MQ type resin consisting of M and Q units of the formula SiO_{4/2} and R^{q}₃SiO_{1/2} wherein at least one R^{q} substituent is a hydrogen atom, and the remainder are alkyl groups. Preferably, the ratio of the total amount of Si—H groups to alkene groups in the silicone release coating composition is in the range of from 1.1:1 to 3:1, most preferably 1.2:1 to 2.5:1. If desired, other types of organohydrogenpolysiloxane cross linking agents can be used, such as the organohydrogenpolysiloxane cross linking agents described in U.S. Pat. No. 6,489,407 (Dec. 3, 2002); the organohydrogenpolysiloxane cross linking agents described in International Publication Number WO 03/093349 (Nov. 13, 2003); and the organohydrogenpolysiloxane cross linking agents described in International Publication Number WO 03/093369 (Nov. 13, 2003).

Some examples of suitable hydrosilylation catalysts include complexes or compounds of group VIII metals, such as platinum, ruthenium, rhodium, palladium, osmium, and indium. Some examples of platinum group metal-containing catalysts useful in preparing the silicone release coating compositions of the present invention are platinum complexes described in U.S. Pat. No. 3,419,593 (Dec. 31, 1968) and U.S. Pat. No. 5,175,325 (Dec. 29, 1992), each incorporated by reference to show such complexes and their preparation.

Other examples of useful platinum group metal-containing catalysts are set forth in U.S. Pat. No. 3,159,601 (Dec. 1, 1964); U.S. Pat. No. 3,220,972 (Nov. 30, 1965); U.S. Pat. No. 3,296,291 (Jan. 3, 1967); U.S. Pat. No. 3,516,946 (Jun. 23, 1970); U.S. Pat. No. 3,814,730 (Jun. 4, 1974); U.S. Pat. No. 3,928,629 (Dec. 23, 1975); U.S. Pat. No. 3,989,668 (Nov. 2, 1976); and U.S. Pat. No. 5,036,117 (Jul. 30, 1991); all incorporated by reference as showing useful platinum group metal-containing catalysts and methods for their preparation.

The platinum-containing catalyst can be platinum metal, platinum metal deposited on a carrier such as silica gel or powdered charcoal, or a compound or complex of a platinum group metal. Some examples of preferred platinum-containing catalysts include chloroplatinic acid, either in its hexahydrate form or its anhydrous form; and/or a platinum-containing catalyst which is obtained by reacting chloroplatinic acid with an aliphatically unsaturated organosilicon compound such as divinyltetramethyldisiloxane; or alkene-platinum-silyl complexes as described in U.S. Pat. No. 6,605,734 (Aug. 12, 2003), such as (COD)Pt(SiMeCl₂)₂, where COD represents 1,5-cyclooctadiene and Me is methyl. These alkene-platinum-silyl complexes may be prepared, for example by mixing 0.015 mole of (COD)PtCl₂, with 0.045 mole of COD, and 0.0612 mole of HMeSiCl₂.

The silicone release coating composition may contain one or more inhibitors adapted to prevent the cure of the silicone release coating composition from occurring below a predetermined temperature. While an inhibitor is not essential to the functioning of the silicone release coating composition itself, it should be understood that in the absence of an inhibitor, the catalyst may initiate and/or catalyze the cure of the silicone release coating composition at ambient temperature, once the three essential constituents have been mixed together.

Some examples of suitable inhibitors include ethylenically or aromatically unsaturated amides, acetylenic compounds, ethylenically unsaturated isocyanates, olefinic siloxanes, unsaturated hydrocarbon diesters, conjugated ene-ynes, hydroperoxides, nitriles and diaziridines. Some specific examples include methyl butynol; dimethyl hexynol or ethynylcyclohexanol; trimethyl(3,5-dimethyl-1-hexyn-3-oxy)silane; maleates such as bis(2-methoxy-1-methylethyl)maleate; fumarates such as diethylfumarate; fumarate/alcohol mixtures wherein the alcohol is benzyl alcohol or 1-octanol and ethenyl cyclohexyl-1-ol.

The silicone release coating composition has a viscosity of 50 mm²/s (centistoke) to 10,000 mm²/s (centistoke) at 25° C., preferably a viscosity of 50-1,000 mm²/s, in order that the branched siloxane is of a suitable viscosity for coating a substrate. If the viscosity is lower than 50 mm²/s, problems may occur with the wetting of a substrate surface by silicone release coating compositions containing the branched siloxane. If the viscosity is higher than 10,000 mm²/s, then silicone release coating compositions containing the branched siloxane are too viscous for uses contemplated by the present application.

If desired, silicone release coating compositions of the invention may also contain a dialkyl alkenyl silyl terminated polydiorganosiloxane having a viscosity at 25° C. of at least 50 mm²/s, such as a dimethyl vinyl silyl terminated polydimethylsiloxane or a dimethyl hexenyl silyl terminated polydimethylsiloxane.

Other constituents may also be added to silicone release coating compositions of the present invention such as fillers, reactive diluents, adhesion promoters, solvents, fragrances, preservatives, and fillers such as silica, quartz and chalk.

Silicone release modifiers may also be included in the silicone release coating composition. The silicone release modifier may consist of one or more of (i) an alkenylated silicone resin, (ii) an alkenylated polydiorganosiloxane, (iii) a primary alkene containing 12-30 carbon atoms, and (iv) a branched alkene containing at least 10 carbon atoms. In addition, the silicone release modifier according to the invention explained hereinafter can also be used.

Bath life extenders can be included in the silicone release coating composition in an amount sufficient to retard the curing reaction at room temperature. Compounds which contain one or more primary or secondary alcohol groups may be used including aliphatic and aromatic alcohols with less than 10 carbon atoms such as methanol, ethanol, propanol, phenol, and cyclohexanol; carboxylic acids; and cyclic ethers.

The silicone release coating compositions may be applied in a solventless manner, in a solvent, or as part of an oil-in-water (O/W) emulsion. The silicone release coating composition can be used for release purposes on a variety of substrates including paper and films. The films may consist of polyethylene, polypropylene, polyester, polystyrene, oriented polypropylene, biaxially oriented polypropylene films, or film coated papers such as polyethylene and polypropylene Kraft papers.

While silicone release coating compositions cured at low temperatures are generally known to have a tendency to provide poor long term anchorage, unexpectedly, it was found that silicone release coating compositions of the present invention both cure at relatively low temperatures, and have improved long term anchorage properties. Good cure is critical so that there is a minimal transfer of silicones to an adhesive such as the adhesive on a label, which in turn, provides a benefit in that the strength of the adhesive is maintained.

The silicone release coating compositions of the invention may be prepared by premixing the three essential constituents (i)-(iii) together, with any optional ingredient(s), it is more desirable to prepare the silicone release coating composition in separate parts or packages such as a kit. In such a case, the portions are combined at the time the silicone release coating composition is to be applied as a coating. Such kits may contain (A) a first part comprising the branched siloxane and the inhibitor, a second part comprising a silicone release modifier and the inhibitor, a third part comprising the catalyst, and a fourth part comprising the cross-linking agent. The kits may also contain (B) a first part comprising the branched siloxane and catalyst, a second part comprising the silicone release modifier and the catalyst, and a third part comprising the cross-linking agent and the inhibitor. In addition, the kits may contain (C) a first part comprising the branched siloxane, the cross-linking agent, and the inhibitor, and a second part comprising the branched siloxane and the catalyst.

As noted above, silicone release modifiers can be added to the silicone release coating composition, including an embodiment of silicone release modifier according to the invention. The silicone release modifier is a composition containing the branched siloxane described above, and at least one of (i) an alkenylated silicone resin, (ii) an alkenylated polydiorganosiloxane, (iii) a primary alkene containing 14-30 carbon atoms, or (iv) a branched alkene containing at least 10 carbon atoms.

The alkenylated silicone resin (i) is an alkenylated MQ resin in which the M groups, i.e., R²₃SiO_{1/2}, are trialkyl siloxy and/or dialkyl alkenyl siloxy groups. The alkenyl group can be cyclohexenyl, vinyl, propenyl, butenyl, pentenyl, or hexenyl. Preferably, the alkenyl group is vinyl or hexenyl. The alkyl groups can be any alkyl groups having 1-6 carbon atoms, preferably methyl. The Q groups, i.e., SiO_{4/2}, and the M groups may be present in any appropriate ratio.

The alkenylated polydiorganosiloxane (ii) is an alkenyldialkyl silyl terminated polydiorganosiloxane containing units of the formula R₂SiO_{2/2} wherein each R group is an alkyl group having 1-6 carbon atoms, or wherein one R group is an alkyl group having 1-6 carbon atoms and the other R group is an alkenyl group having 1-6 carbon atoms, preferably vinyl or hexenyl.

The primary alkene (iii) may be any primary alkene containing 10-30 carbon atoms such as tetradecene and octadecene.

The branched alkene (iv) is a composition of the formula: 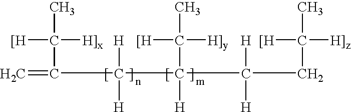
wherein the number n of the methylene groups and the number m of the branched alkyl groups are randomly distributed in the chain; n and m are each independently 0 or 1-20; and x, y, and z are each independently 1-12. Preferably, the total number of carbon atoms in the alkene should be at least 20. The silicone release modifier preferably contains 25-85 percent by weight of the branched siloxane, with the remainder to 100 percent being one or more of components (ii)-(iv).

Silicone release modifiers according to the invention may be incorporated into the silicone release coating composition according to the invention, or they may be incorporated into any state of the art silicone release coating compositions which contain an alkenylated polyorganosiloxane, an organohydrogenpolysiloxane cross-linking agent, and an effective amount of a hydrosilylation catalyst.

### EXAMPLES

The following examples are set forth in order to illustrate the invention in more detail.

The following examples relate to evaluations carried out in order to determine the improvements in release profile and the reduction of chatter or zippiness provided as a result of using the trimethylsilyl, vinyldimethylsilyl-terminated poly(dimethylsiloxane-silicate) copolymers of the invention.

### Example A

### Method 1

### Preparation of Mixed Trimethylsilyl, Vinyldimethylsilyl-terminated Poly(dimethylsiloxane-silicate) Copolymers

A reaction vessel was charged with the amounts shown in Table A of tetrakis(vinyldimethylsiloxy)silane having the structure [(Vi(CH₃)₂SiO_{1/2})₄(SiO_{4/2})], octamethylcyclotetrasiloxane D₄, tetrakis(trimethylsiloxy)silane, and 10 parts per million of polyaminophosphenium hydroxide catalyst. The reaction mixture was stirred for one hour at a temperature of 150° C. The mixture was cooled, and 5 parts per million of bis-trimethylsilylhydrogenphosphate was added to neutralize the catalyst. The reaction mixture was filtered through a cartridge filter, and the reaction mixture was stripped at a temperature of about 200° C. and a pressure of 0.8 mm Hg. The final product was analyzed by measuring its viscosity, and a structural determination was made by Nuclear Magnetic Resonance (NMR) and Near InfraRed (NIR) Spectroscopy analytical techniques to confirm that the degree of polymerization (DP) and the percent of vinyl content matched theory. Based on these procedures, ranges of polymers were prepared, and are shown in Table A.

TABLE A
Trimethylsilyl, Vinyldimethylsilyl-terminated Poly(dimethylsiloxane-silicate)
Copolymers Prepared by Method 1.

| | Endblocker, | Grams D₄ | Viscosity | Polymer DP, % | Actual %, w/w |
|---|---|---|---|---|---|
| Example | grams | Cyclic | mPa · s | Trimethylsilyl | Vinyl |
| 1 | A (48.2) | 1944 | 275 | 200 DP 15% | 0.60 |
| | B (7.6) | | | | |
| 2 | A (45.4) | 1944 | 300 | 200 DP 20% | 0.56 |
| | B (10.1) | | | | |
| 3 | A (62.7) | 1261 | 100 | 100 DP 15% | 1.10 |
| | B (9.8) | | | | |
| 4 | A (51.5) | 1262 | 100 | 100 DP 30% | 0.91 |
| | B (19.7) | | | | |
| Comparison | A (21.6) | 592 | 189 | 159 DP | 0.88 |
| Polymer A | | | | | |
| Comparison | A (21.6) | 370 | 101 | 99 DP | 1.38 |
| Polymer B | | | | | |

### Example B

### Method 2

### Preparation of Trimethylsilyl, Vinyldimethylsilyl-terminated Poly(dimethylsiloxane-silicate) Copolymers

A reaction vessel was charged with the amounts shown in Table B of tetrakis(vinyldimethylsiloxy)silane having the structure [(Vi(CH₃)₂SiO_{1/2})₄(SiO_{4/2})], octamethylcyclotetrasiloxane, a linear trimethylsilyl-terminated poly(dimethylsiloxane) polymer, and 10 parts per million of polyaminophosphenium hydroxide catalyst. The reaction mixture was stirred for one hour at a temperature of 150° C. The mixture was then cooled and 5 parts per million of bis-trimethylsilylhydrogenphosphate was added to neutralize the catalyst. The reaction mixture was filtered through a cartridge filter, and the reaction mixture was stripped at a temperature of about 150° C. and a pressure of 40 millibars for two hours. The final product was analyzed by measuring its viscosity, and structural determinations were made by NMR and NIR to confirm that the DP and the percent vinyl content matched theory. Based on these procedures, ranges of polymers were prepared, and are shown in Table B.

TABLE B
Trimethylsilyl, Vinyldimethylsilyl-terminated Poly(dimethylsiloxane-silicate)
Copolymers Prepared by Method 2.

| | Endblocker, | Gram D₄ | Viscosity | Polymer DP, % | Actual %, w/w |
|---|---|---|---|---|---|
| Example | gram | Cyclics | (mPa · s) | Trimethylsilyl | Vinyl |
| Example 5 | A (479) | 14338 | 156 | 138 DP 14% Me | 0.75 |
| | C (546) | | | | |
| Example 6 | A (734) | 14060 | 98 | 102 DP 19% Me | 1.06 |
| | C (1046) | | | | |
| Example 7 | A (104.9) | 3383 | 203 | 166 DP 15% Me | 0.72 |
| | D (13.9) | | | | |
| Example 8 | A (98.7) | 3382 | 196 | 164 DP 20% Me | 0.69 |
| | D (18.5) | | | | |
| Example 9 | A (70.7) | 3364 | 359 | 240 DP 10% Me | 0.54 |
| | D (18.5) | | | | |
| Example 10 | A (66.8) | 3364 | 386 | 253 DP 15% Me | 0.48 |
| | D (8.8) | | | | |
| Example 11 | A (62.8) | 33643 | 404 | 252 DP 20% Me | 0.45 |
| | D (11.3) | | | | |
| Example 12 | A (56.8) | 3436 | 513 | 296 DP 15% Me | 0.41 |
| | D (7.5) | | | | |
| Example 13 | A (53.5) | 3437 | 572 | 309 DP 20% Me | 0.37 |
| | D (10.1) | | | | |

In Table A and Table B, Endblocker A was tetrakis(vinyldimethylsiloxy)silane; Endblocker B was tetrakis(trimethylsiloxy)silane; Endblocker C was a trimethylsiloxy-terminated polydimethylsiloxane fluid having a viscosity of 10 centistoke; and Endblocker D was hexamethyldisiloxane. The viscosity measurements were conducted with the aid of Brookfield LVT rotational viscometer.

Silicon 29 Nuclear Magnetic Spectroscopy (²⁹Si NMR) data was collected on a Varian Mercury 300 instrument using a deuterated chloroform solvent. This determination was conducted with a relaxation delay of 60 seconds with a gated decoupled pulse sequence, using a 5 mm switchable PFG probe. In some instances, as an alternative, the determination was made using a Mercury 400 instrument having a Nalorac 16 mm silicon-free Pulsetune® probe with 0.03 M Cr(acac)₃ as a relaxation reagent, and gated decoupling to ensure quantitative conditions. Both instruments used a 90 degree pulse width and the Mercury 400 instrument used a 12 second relaxation delay.

The vinyl percentage was measured using a Nicolet Fourier Transform Near Infra-Red Spectroscopy instrument. The vinyl levels were determined by conditioning samples at 30° C. in a glass vial, scanning the samples using a resolution of 8 cm⁻¹, 60 scans and a clear beam background, followed by quantification.

### Example 14

### Performance Evaluation

The following examples provide a comparison between the cure performance obtained by using the trimethylsilyl, vinyldimethylsilyl-terminated poly(dimethylsiloxane-silicate) copolymers prepared above, versus using polymers which have no trimethysiloxy endblocking. In these examples, each composition was applied on a glassine paper manufactured by UPM Kymmeme Corporation ADS, Helsinki, Finland. The paper consisted of 59 g/m² Tervasaari Honey 53 glassine paper. A pilot coater with a moving web was used. The speed was selected to provide a dwell time of two seconds in the oven. The resulting coatings were cured at various web temperatures. Each silicone based release coating composition contained the polymer as indicated in Table C, blended with 40 ppm of a platinum catalyst, a homopolymer crosslinker (XLA) containing SiH groups, and using a sufficient amount of the crosslinking agent to provide an SiH:Vi ratio of 1.8. The formulation also contained 0.2 percent by weight of di-allyl maleate.

The cure characteristics of the resulting coatings were assessed with respect to migration, smear, and finger rub-off. Migration was measured by placing a strip of adhesive, i.e., Sellotape®, on the cured release coating, and after its removal, determining if any of the coating had been transferred to the adhesive tape, in a self-delamination test. Smear was measured by pushing a finger of the hand over the cured coating, and determining if there was any visible mark left in the form of a smear. Finger rub-off was measured by rubbing a finger of the hand firmly over the paper, back and forth for 10 cycles, and determining if any of the coating had been damaged or removed. N/N/N means that there was no migration/no smear/no rub-off.

The cure characteristics of the coatings were further assessed by measuring the percentage of extractables in the coatings after their cure. This was performed by first determining the coating weight of a standard sized sample of a substrate with a cured coating by x-ray fluorescence using a LabX 3000 X-ray fluorescence spectrometer manufactured by Oxford Instruments PLC, Oxon, United Kingdom. The coated samples were then placed in a solution of methyl isobutyl ketone solvent, to extract any unreacted siloxane which has not been cross-linked into the coating matrix, or which had adhered to the substrate. After a predetermined period of time, the sample was removed from the solvent, dried, and re-weighed.

The percentage extractables shown in Table C are the percentage weight losses after the unreacted silicone had been removed from the coating. It should be noted that within certain limits, the samples containing the trimethylsilyl, vinyldimethylsilyl-terminated poly(dimethylsiloxane-silicate) copolymers of the invention, provided less than 5 percent extractables data. In order to achieve adequate cure, however, the level of trimethyl end groups has to be maintained below about 25 mol percent relative to all end groups in the copolymer. Above this level, amounts of extractables in excess of 5 percent are likely to occur as can be seen in Table C.

TABLE C
Impact of Polymer Type and Temperature on Cure and Level of Extractables

| | 140° C. | | 150° C. | | 160° C. | |
|---|---|---|---|---|---|---|
| Polymer | Cure | Ext, % | Cure | Ext, % | Cure | Ext, % |
| Comparative Polymer A | NNN | 2.1 | NNN | 1.6 | NNN | 1.3 |
| Example 5 138 DP 14% Me | NNN | 4.6 | NNN | 4.2 | NNN | 3.6 |
| Example 6 102 DP 19% Me | NNN | 4.5 | NNN | 4.0 | NNN | 3.8 |
| Example 4 100 DP 30% Me | MNN | 8.5 | sMNN | 7.6 | sMNN | 7.1 |

In Table C, MNN means Migration, No smear, and No rub-off; sMNN means slight Migration, No smear, and No rub-off; and N/N/N means that there was No migration/No smear/No rub-off.

### Example 15

The following examples were carried out to demonstrate the variation in the initial anchorage of a release coating containing the trimethylsilyl, vinyldimethylsilyl-terminated poly(dimethylsiloxane-silicate) copolymers prepared above, versus polymers which have no trimethylsiloxy endblocking. Each composition was applied on the glassine paper noted above in Example 14, using a pilot coater with a moving web. The speed was selected to provide a dwell time of two seconds in the oven. The resulting coatings were cured at various web temperatures. Each silicone based release coating composition contained the polymer indicated in Table D, which had been blended with 100 ppm of a platinum catalyst, a copolymer crosslinker (XLC) containing SiH groups, and a sufficient amount of crosslinking agent to provide an SiH:Vi ratio of 1.8. The formulation also contained 0.2 percent by weight of di-allyl maleate.

Anchorage or adhesion of the coating was assessed by the finger rub-off method. Rub-off was measured by rubbing the finger of the hand over the paper, back and forth for ten cycles, and determining if any of the coating had been damaged or removed. These results are shown in the Table D.

TABLE D
Impact of Polymer Type on Initial Rub-off

| | 140° C. | 150° C. | 160° C. |
|---|---|---|---|
| Polymer | Cure | Cure | Cure |
| Comparative Polymer A | NNGRO | NNGRO | NNGRO |
| Example 5 138 DP 14% Me | NNN | NNN | NNN |

In Table D, NNGRO means No migration, No smear, Gross Rub-Off. N/N/N means that there was No migration/No smear/No rub-off.

### Example 16

The following examples were conducted to show the variation in the delayed anchorage or adhesion of a variety of cured release coatings, over an extended period of time, on a non-corona treated polyethylene terephthlate (PET) film (36 micron). Each silicone based release coating composition contained the polymer indicated in Table E, which had been blended with 120 ppm of a platinum catalyst, a homopolymer crosslinker (XLD) containing 1.6 percent by weight of SiH (as H), a release modifier consisting of 75 percent by weight of an MQ resin with trimethylsilyl and vinydimethylsilyl functionality, dispersed in an olefin mixture, and having a viscosity of about 500 centipoise and a vinyl content of 2.2 percent by weight. A sufficient quantity of crosslinking agent was added to provide an SiH:Vi ratio of 2.6. The formulation also contained 0.6 percent by weight of ethynylcyclohexanol (ETCH).

The system was cured at 150° C. and a dwell time of 2.4 seconds was selected. The samples were then adhesive coated within two hours after the cure, using a tackified acrylic emulsion adhesive composition applied with a 60 micron gap applicator, and cured for 30 seconds at 120° C. in a convection oven. It was then laminated with a standard vellum paper. The laminates were maintained at room temperature and approximately 50 percent relative humidity (RH) under two 10 kg weights. A test of delayed rub-off was made on a regular basis over time to assess the efficiency of the silicone anchorage on the polyethylene terephthlate film. The test used to assess delayed rub-off is the finger test described in Example 14.

TABLE E
Impact of Polymer Type on Delayed Rub-off

| | Initial | 1 Day | 3 Days | 7 Days | 15 Days | 1 Month |
|---|---|---|---|---|---|---|
| Polymer | Cure | Cure | Cure | Cure | Cure | Cure |
| Comparative | NNN | vsRO | RO | GRO | GRO | GRO |
| Polymer A | | | | | | |
| Comparative | NNN | sRO | GRO | GRO | GRO | GRO |
| Polymer B | | | | | | |
| Example 1 | NNN | NNN | NNN | vsRO | RO | RO |
| Example 2 | NNN | NNN | NNN | NNN | NNN | sRO |
| Example 3 | NNN | NNN | vsRO | sRO | RO | RO |

In Table E, vsRO means very slight Rub-off; sRO means slight Rub-off; RO means Rub-off; GRO means Gross rub-off; and N/N/N means No migration/No smear/No rub-off.

Release performance tests were also conducted by delamination from laminates prepared with a hot melt adhesive and a water-based acrylic adhesive. The laminated papers were aged for 1, 7, and 15 days, respectively, to determine the release force values over a range of peel speeds. The laminates were aged under two 10 kg weights at a temperature of 70° C., to ensure an intimate wetting of the adhesive on the silicone-based coating. Delamination was carried out with (i) a Model ZPE-1000 High Rate Peel Tester manufactured by Instrumentors Inc., Strongsville, Ohio, or (ii) a Model LRX Low Speed Peel Rate Tester manufactured by Lloyd Instruments Limited, Hampshire, United Kingdom, at a variety of speeds. These formulations are shown in Table F, and the results are shown in Table G through Table I. It can be clearly seen that the trimethylsilyl, vinyldimethylsilyl-terminated poly(dimethylsiloxane-silicate) copolymers of the invention, i.e., Baths 3, 5, and 7, provide lower release forces at high speed, compared to analogous branched siloxane structures having no trimethysiloxy endblocked groups, i.e., Baths 2, 4, and 6.

The method to predict zippiness was done by measurement of the release force at low peel speed such as in Finat Test Method 3 (FTM 3). This consisted of assessing the level of zippiness visually on a release force diagram measured at 0.3 m/min. The levels were reported as values ranging between No Zippiness, Low Zippiness, Medium Zippiness, and High Zippiness. The value of the initial peak spike was also recorded by measurement of the release force at higher delamination speeds (e.g., at 10 m/min. or 100 m/min.) such as described in Finat Test Method (FTM 4). During release measurement, an initial spike is observed before the release force drops to a constant force. The relationship between the initial spike force and the average value force provides an indication whether the initiation spike intensity is high, medium or low, when the coating is used in a high-speed delamination process.

Performance evaluations of Baths 3, 5, and 7, show that the trimethylsilyl, vinyldimethylsilyl-terminated poly(dimethylsiloxane-silicates) copolymers of the invention, where the trimethyl endcapping was below 25 mole percent, had an overall superior balance of release coating properties. Good cure, initial anchorage, and rub-off resistance were achieved, and at the same time the zippiness behavior was in the low category.

TABLE F
Bath Formulations

| | Bath | | | | | | |
|---|---|---|---|---|---|---|---|
| | 1 | 2 | 3 | 4 | 5 | 6 | 7 |
| Polymer | Comparative | Comparative | Ex. 5 | Comparative | Ex. 6 | Comparative | Ex. 6 |
| | Polymer C | Polymer A | | Polymer B | | Polymer B | |
| Release Modifier | A | A | A | None | None | A | A |
| Vinyl Level | 2.2 | 2.2 | 2.2 | 2.2 | 2.2 | 2.2 | 2.2 |
| Release Modifier, % | | | | | | | |
| Crosslinker | XLA | XLB | XLB | XLA | XLA | XLB | XLB |
| Desired SiH:SiVi | 1.75 | 1.75 | 1.75 | 1.75 | 1.75 | 1.75 | 1.75 |
| Formulation, gram | | | | | | | |
| Polymer | 300 | 300 | 300 | 300 | 300 | 300 | 300 |
| Release Modifier | 51 | 51 | 51 | | | 51 | 51 |
| Catalyst | 7.03 | 1.41 | 1.41 | 2.81 | 2.81 | 2.81 | 2.81 |
| Crosslinker | 19.74 | 81.43 | 71 | 18.69 | 14.40 | 113.84 | 92.96 |

Some details of the materials, compositions, and ingredients referred to above in the Examples and Tables are shown below:
(i) Comparative Polymer A was a vinyldimethylsiloxy terminated poly(dimethylsiloxane-silicate) copolymer having a viscosity of 185 centistoke and a vinyl content of 0.9 percent by weight.
(ii) Comparative Polymer B was a vinyldimethylsiloxy terminated poly(dimethylsiloxane-silicate) copolymer having a viscosity of 110 centistoke and a vinyl content of 1.4 percent by weight.
(iii) Comparative Polymer C was a vinyldimethylsiloxy terminated poly(dimethyl,methylvinylsiloxane) copolymer having a viscosity of 250 centistoke and a vinyl content of 1.1 percent by weight.
(iv) Crosslinker XLA was a trimethylsiloxy terminated polymethylhydrogensiloxane fluid having an SiH (as H) content of 1.5 percent by weight.
(v) Crosslinker XLB was a cyclic methylhydrogen dimethylsiloxane hydrocarbonyl copolymer fluid having an SiH (as H) content of 0.3 percent by weight, and a commercial product available from the Dow Corning Corporation, Midland, Mich.
(vi) Crosslinker XLC was a trimethysiloxy-terminated dimethylmethylhydrogen copolymer having an SiH content of 1.0 percent by weight.
(vii) Crosslinker XLD was a trimethylsiloxy-terminated polymethylhydrogensiloxane fluid having an SiH (as H) content of 1.6 percent by weight and having a higher molecular weight than XLA.
(viii) Modifier A was a release modifier formulation consisting of 45 percent by weight of an MQ resin containing trimethylsilyl and vinydimethylsilyl functionality, dispersed in a vinyldimethylsilyl-terminated poly(dimethylsiloxane) polymer, having a viscosity of about 800 centipoise, and containing 2.2 weight percent of vinyl.
(ix) Inhibitor(s) used were diallylmaleate, bis(2-methoxy-1-methylethyl)maleate, or ethynylcyclohexanol.
(x) Catalyst was a vinyl polymer diluted platinum complex consisting of 1,3-diethenyl-1,1,3,3-tetramethyldisiloxane in which the level of platinum is about 5200 ppm.
(xi) Acrylic Adhesive Emulsion was a commercially available tackified emulsified acrylic adhesive composition.

(xii) Hot Melt Adhesive was a commercially available styrene-butadiene based hot melt adhesive composition.

TABLE G
Liners Laminated with Tackified Emulsion Water-based
Adhesive. Release Force (RF) was Measured after
One Day at Room Temperature.

| | | RF at | RF at | RF at | RF at |
|---|---|---|---|---|---|
| Bath | Ext, % | 0.3 m/min | 10 m/min | 100 m/min | 300 m/min |
| Bath 1 | 2.8 | 7.4 | 14.6 | 24.6 | 37.1 |
| Bath 2 | 1.9 | 6.7 | 17.7 | 54.0 | 75.4 |
| Bath 3 | 4.7 | 6.1 | 12.1 | 44.1 | 63.2 |
| Bath 4 | 1.7 | 7.4 | 12.0 | 24.6 | 33.1 |
| Bath 5 | 4.3 | 7.5 | 10.7 | 22.3 | 31.9 |
| Bath 6 | 1.8 | 7.7 | 13.3 | 49.2 | 61.1 |
| Bath 7 | 4.9 | 6.5 | 12.1 | 39.9 | 53.1 |

TABLE H
Release Forces Dry Laminated with a Hot Melt Adhesive
and Measured after One Day at 70° C.

| | | | | | | Zippiness | Initiation Spike |
|---|---|---|---|---|---|---|---|
| | | RF at | RF at | RF at | RF, | Assessment | Intensity |
| | Cure | 0.3 m/min | 10 m/min | 100 m/min | 300 m/min | (at 0.3 m/min) | (at 10 m/min) |
| Bath 1 | NNN | 6.9 | 5.9 | 14.2 | 16.1 | Medium | Medium |
| Bath 2 | NNN | 3.4 | 8.6 | 34.1 | 47.5 | Low | Low |
| Bath 3 | NNN | 3.5 | 1.9 | 32.5 | 34.9 | Low | Low |
| Bath 4 | NNN | 5.0 | 5.3 | 10.7 | 13.3 | Low | Low |
| Bath 5 | NNN | 1.4 | 5.4 | 11.7 | 13.8 | Low | Low |
| Bath 6 | NNN | 3.6 | 7.6 | 30.4 | 34.9 | Low | Low |
| Bath 7 | NNN | 1.9 | 10.3 | 23.3 | 26.1 | Low | Low |

TABLE I
Release Forces Dry Laminated with a Hot Melt Adhesive
and Measured after Two Weeks at 70° C.

| | | | | | Zippiness | Initiation Spike |
|---|---|---|---|---|---|---|
| | RF at | RF at | RF at | RF, | Assessment | Intensity |
| | 0.3 m/min | 10 m/min | 100 m/min | 300 m/min | (at 0.3 m/min) | (at 10 m/min) |
| Bath 1 | 57.5 | 13.5 | 19.4 | 21.8 | High | High |
| Bath 2 | 10.2 | 13.1 | 37.1 | 52.0 | Low | Low |
| Bath 3 | 11.5 | 16.6 | 40.1 | 45.7 | Low | Low |
| Bath 4 | 54.7 | 12.8 | 15.9 | 18.3 | High | High |
| Bath 5 | 25.9 | 12.9 | 18.2 | 19.4 | Medium | Medium |
| Bath 6 | 18.8 | 15.4 | 28.2 | 35.7 | Low | Low |
| Bath 7 | 22.9 | 23.2 | 34.1 | 34.8 | Low | Low |

Other variations may be made in compounds, compositions, and methods described herein without departing from the essential features of the invention. The embodiments of the invention specifically illustrated herein are exemplary only and not intended as limitations on their scope except as defined in the appended claims.

1. A method of preparing a branched siloxane comprising the steps of:
(A) mixing:
(i) a compound of the formula (SiO_{4/2})(R^{a}R^{b}₂SiO_{1/2})₄;
(ii) a cyclic polydiorganosiloxane; and
(iii) a substantially linear trimethylsiloxy terminated polydiorganosiloxane; or
(iv) a compound having the general formula (SiO_{4/2})(R^{c}R^{d}₂SiO_{1/2})₄;
wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; R^{c} is an hydroxy group, an alkoxy group, or an alkyl group; and R^{d} is the same as R^{b}.
(B) causing the mixture in (A) to react in the presence of an acid catalyst or a phosphazene base catalyst at a temperature less than about 180° C.; and
(C) neutralizing the reaction mixture of (B).

2. The method as claimed in claim 1 wherein compound (i) has the formula (SiO_{4/2})(ViMe₂SiO_{1/2})₄ where Vi represents a vinyl group and Me represents a methyl group.

3. The method as claimed in claim 1 wherein the cyclic polydiorganosiloxane (ii) is octamethylcyclotetrasiloxane.

4. The method as claimed in claim 1 wherein compound (iv) is tetrakis(trimethylsiloxy)silane.

5. The method as claimed in claim 1 wherein compound (iv) is trimethylsiloxy-terminated polydimethylsiloxane having a viscosity of 10 centistoke.

6. The method as claimed in claim 1 wherein compound (iv) is hexamethyldisiloxane.

7. The method as claimed in claim 1 wherein the catalyst is a phosphazene base catalyst.

8. A method of improving the release coating properties of a silicone release coating composition, including improving its cure, initial anchorage, and rub-off resistance; reducing zippiness; and controlling release forces at high delamination speeds; comprising:
(A) applying to the surfaces of paper and film substrates, a silicone release coating composition comprising:
(i) a branched siloxane having the formula: 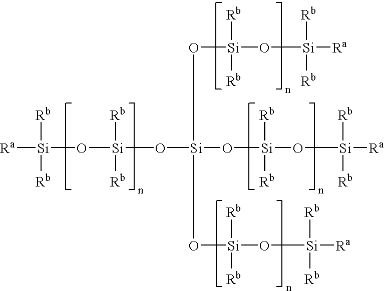
wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups;
(ii) an organohydrogenpolysiloxane cross-linking agent, in an amount such that the ratio of total number of Si—H groups in the silicone release coating composition to aliphatically unsaturated hydrocarbon groups in the silicone release coating composition is 1:1 to 5:1;
(iii) a sufficient amount of a hydrosilylation catalyst effective to catalyze the reaction between branched siloxane (i) and cross-linking agent (ii); and
(iv) at least one of a hydrosilylation inhibitor, a linear alkenyl terminated polydiorganosiloxane, a bath life extender, a silicone release modifier, an adhesion promoter, a filler, a reactive diluent, or an anchorage improving additive; and
(B) curing the composition.

9. The method as claimed in claim 8 wherein 3.2 to 3.9 of the R^{a} groups are vinyl group, the remainder of the R^{a} groups are methyl and each R^{b} group is a methyl group.

10. The method as claimed in claim 8 wherein the organohydrogenpolysiloxane cross-linking agent has the formula
R^{t}₃SiO_{1/2}((CH₃)₂SiO_{2/2})_{d}(R^{t}₂SiO_{2/2})ₑ)SiO_{1/2}R^{t}₃
wherein each R^{t} is an alkyl group having 1-4 carbon atoms, an epoxy group such as allylglycidoxy and ethylcyclohexylepoxy, or hydrogen; d is 0 or a positive number; e is an integer such that d+e is from 8-100 with the proviso that at least one R^{t} be a hydrogen.

11. The method as claimed in claim 8 wherein the organohydrogenpolysiloxane cross-linking agent may comprise an MQ type resin consisting of M and Q units of the formula SiO_{4/2} and R^{q}₃SiO_{1/2} wherein at least one R^{q} substituent is a hydrogen atom, and the remainder are alkyl groups.

12. A method according to claim 8 in which the film substrates comprise polyethylene, polypropylene, polyester, polystyrene, oriented polypropylene, biaxially oriented polypropylene, polyethylene coated Kraft paper, or polypropylene coated Kraft paper.

13. A branched siloxane comprising a composition having the formula: 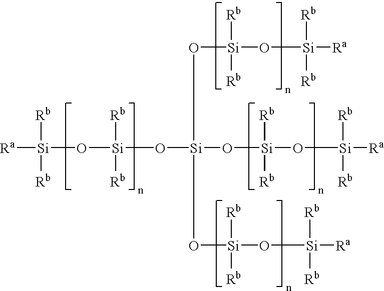
wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups.

14. The branched siloxane as claimed in claim 13 wherein 3.2 to 3.9 of the R^{a} groups are vinyl group, the remainder of the R^{a} groups are methyl and each R^{b} group is a methyl group.

15. A silicone release coating composition comprising:
(i) a branched siloxane having the formula: 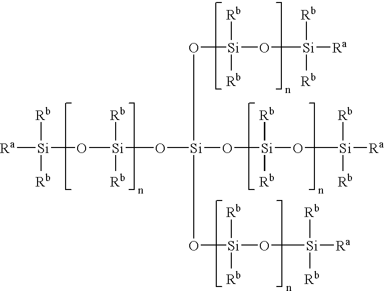
wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups;
(ii) an organohydrogenpolysiloxane cross-linking agent, in an amount such that the ratio of total number of Si—H groups in the silicone release coating composition to aliphatically unsaturated hydrocarbon groups in the silicone release coating composition is 1:1 to 5:1;
(iii) a sufficient amount of a hydrosilylation catalyst effective to catalyze the reaction between branched siloxane (i) and cross-linking agent (ii); and
(iv) at least one of a hydrosilylation inhibitor, a linear alkenyl terminated polydiorganosiloxane, a bath life extender, a silicone release modifier, an adhesion promoter, a filler, a reactive diluent, or an anchorage improving additive.

16. The silicone release coating composition claimed in claim 15 wherein the organohydrogenpolysiloxane cross-linking agent has the formula
R^{t}₃SiO_{1/2}((CH₃)₂SiO_{2/2})_{d}(R^{t}₂SiO_{2/2})ₑ)SiO_{1/2}R^{t}₃
wherein each R^{t} is an alkyl group having 1-4 carbon atoms, an epoxy group such as allylglycidoxy and ethylcyclohexylepoxy, or hydrogen; d is 0 or a positive number; e is an integer such that d+e is from 8-100 with the proviso that at least one R^{t} be a hydrogen.

17. The silicone release coating composition as claimed in claim 15 wherein the organohydrogenpolysiloxane cross-linking agent may comprise an MQ type resin consisting of M and Q units of the formula SiO_{4/2} and R^{q}₃SiO_{1/2} wherein at least one R^{q} substituent is a hydrogen atom, and the remainder are alkyl groups.

18. An article of manufacture comprising a substrate having on its surface a layer containing a cured silicone release coating composition according to claim 15.

19. A silicone release modifier composition comprising:
(A) a branched siloxane having the formula: 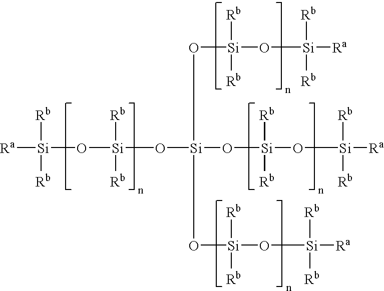
wherein R^{a} is an alkyl group having 1-6 carbon atoms, an alkenyl group having 2-6 carbon atoms, or an alkynyl group having 2-6 carbon atoms; R^{b} is an alkyl group having 1-6 carbon atoms, an alkenyl group having 2-6 carbon atoms, an aryl group, an alkoxy group, an acrylate group, or a methacrylate group; n is 1-200; and provided that at least 3.2-3.9 of the R^{a} groups in the branched siloxane are alkenyl or alkynyl groups; and
(B) at least one of (i) an alkenylated silicone resin, (ii) an alkenylated polydiorganosiloxane, (iii) a primary alkene containing 14-30 carbon atoms, and (iv) a branched alkene containing at least 14 carbon atoms.
